(19) United States
(12) Patent Application Publication
(10) Pub. No.: US 2001/0050234 A1
(43) Pub. Date: Dec. 13, 2001

(54) Electrochemical cell system

(76) Inventor: Jason K. Shiepe, Middletown, CT (US)

Correspondence Address: CANTOR COLBURN LLP, 55 Griffin Road South, Bloomfield, CT, 06002, US

(21) Appl. No.: 09/745,366

(22) Filed: Dec. 22, 2000

Related U.S. Application Data
(60) Provisional application No. 60/171,369, filed on Dec. 22, 1999.

(51) Int. Cl. C25B 1/10; C25B 11/12; C25B 9/00; C25B 11/03; C25B 11/04; H01M 8/10; H01M 4/86; H01M 4/90; H01M 4/96

(52) U.S. Cl. 205/629; 205/630; 204/252; 204/260; 204/291; 204/294; 204/283; 429/30; 429/31; 429/40

(57) ABSTRACT

An electrochemical cell system is disclosed, wherein a MEA is provided within a vessel. The MEA includes a first electrode, a second electrode, and a membrane disposed between and in intimate contact with the first electrode and the second electrode. The vessel is disposed around the MEA, and defines a first storage area in fluid communication with the first electrode. The MEA defines a second storage region in fluid communication the second electrode.

### CROSS-REFERENCE TO RELATED APPLICATIONS

This application claims the benefit of the Provisional application Ser. No. 60/171,369 filed Dec. 22, 1999, which is hereby incorporated by reference.

### TECHNICAL FIELD

The present disclosure relates to an electrochemical cell system, and especially relates to the use internal reactant and fluid storage areas in a fully integrated electrochemical cell.

### BRIEF DESCRIPTION OF THE RELATED ART

Electrochemical cells are energy conversion devices, usually classified as either electrolysis cells or fuel cells. An electrolysis cell typically generates hydrogen by the electrolytic decomposition of water to produce hydrogen and oxygen gases, whereas ina fuel cell hydrogen typically reacts with oxygen to generate electricity. Referring to FIG. 1, a partial section of a typical proton exchange membrane fuel cell 10 is detailed. In fuel cell 10, hydrogen gas 12 and reactant water 14 are introduced to a hydrogen electrode (anode) 16, while oxygen gas 18 is introduced to an oxygen electrode (cathode) 20. The hydrogen gas 12 for fuel cell operation can originate from a pure hydrogen source, methanol or other hydrogen source. Hydrogen gas electrochemically reacts at anode 16 to produce hydrogen ions (protons) and electrons, wherein the electrons flow of from anode 16 through an electrically connected external load 21, and the protons migrate through a membrane 22 to cathode 20. At cathode 20, the protons and electrons react with the oxygen gas to form resultant water 14′, which additionally includes any reactant water 14 dragged through membrane 22 to cathode 20. The electrical potential across anode 16 and cathode 20 can be exploited to power an external load.

The same configuration as is depicted in FIG. 1 for a fuel cell is conventionally employed for electrolysis cells. In a typical anode feed water electrolysis cell (not shown), process water is fed into a cell on the side of the oxygen electrode (in an electrolytic cell, the anode) to form oxygen gas, electrons, and protons. The electrolytic reaction is facilitated by the positive terminal of a power source electrically connected to the anode and the negative terminal of the power source connected to a hydrogen electrode (in an electrolytic cell, the cathode). The oxygen gas and a portion of the process water exit the cell, while protons and water migrate across the proton exchange membrane to the cathode where hydrogen gas is formed. In a cathode feed electrolysis cell (not shown), process water is fed on the hydrogen electrode, and a portion of the water migrates from the cathode across the membrane to the anode where protons and oxygen gas are formed. A portion of the process water exits the cell at the cathode side without passing through the membrane. The protons migrate across the membrane to the cathode where hydrogen gas is formed.

In certain arrangements, the electrochemical cells can be employed to both convert electricity into hydrogen, and hydrogen back into electricity as needed. Such systems are commonly referred to as regenerative fuel cell systems.

The typical electrochemical cell system includes a number of individual cells arranged in a stack, with the working fluid directed through the cells via input and output conduits formed within the stack structure. The cells within the stack are sequentially arranged, each including a cathode, a proton exchange membrane, and an anode. In certain conventional arrangements, the anode, cathode, or both are gas diffusion electrodes that facilitate gas diffusion to the membrane. Each cathode/membrane/anode assembly (hereinafter “membrane electrode assembly”, or “MEA”) is typically supported on both sides by flow fields comprising screen packs or bipolar plates. Such flow fields facilitate fluid movement and membrane hydration and provide mechanical support for the MEA.

Gas and fluid supply lines feed the electrochemical cell system the required reactants and remove the products formed in the reaction. The cell system is furthermore configured with ports that enable the fluid (i.e., liquid and gas) storage devices to remain in fluid communication with the active area of the electrochemical cell. Pumps are used to move the reactants and products to and from the cell system. This use of external pumps and storage areas both limits the ease with which cell or cell stack may be moved, and complicates the use of electrochemical cells in locations where pumps and storage tanks are difficult to introduce or operate. Accordingly, while existing electrochemical cell systems are suitable for their intended purposes, there still remains a need for improvements, particularly regarding operation of electrochemical cell systems with minimal reliance on external pumps or storage units. There further remains a need for electrochemical cell systems that may be easily moved to any location where a power source or a power storage unit is needed.

### SUMMARY OF THE INVENTION

The above-described drawbacks and disadvantages are alleviated by an electrochemical cell system comprising a MEA provided within a vessel. The MEA includes a first electrode, a second electrode, and a membrane disposed between and in intimate contact with the first electrode and the second electrode. The vessel is disposed around the MEA, and defines a first storage area in fluid communication with the first electrode. The MEA defines a second storage region in fluid communication the second electrode. The above discussed and other features and advantages will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike in the several Figures:

FIG. 1 is a schematic diagram of a prior art electrochemical cell showing an electrochemical reaction;

FIG. 2 is a perspective view of one embodiment of an electrochemical system of the present invention having a cylindrical shape; and

FIG. 3 is a cross sectional view of the electrochemical system shown in FIG. 2 through lines 3-3.

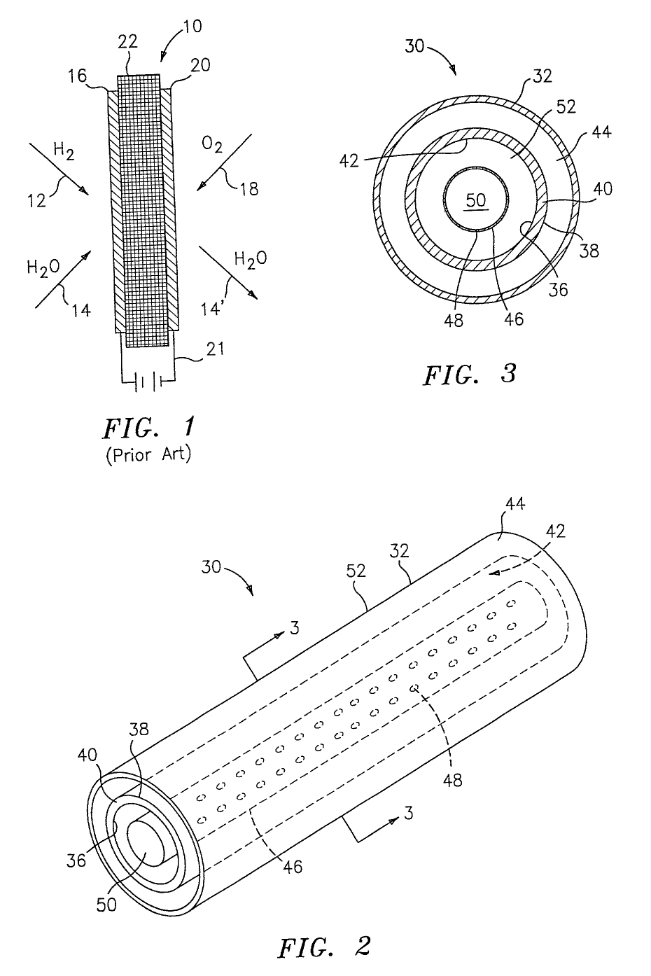

### DETAILED DESCRIPTION OF THE PREFERRED EMBODIMENTS

Although the present invention will be described in relation to a proton exchange membrane electrochemical cell employing hydrogen, oxygen, and water, it is to be understood that this invention can be employed with all types of electrochemical cells. Additionally, all types of electrolytes may be used, including, but not limited to phosphoric acid, solid oxide, potassium hydroxide, and the like. Various reactants can also be used, including, but not limited to hydrogen bromine, oxygen, air, chlorine, and iodine. Upon the application of different reactants and/or different electrolytes, the flows and reactions are understood to change accordingly, as is commonly understood in relation to that particular type of electrochemical cell.

The electrochemical cell system has one or more electrochemical cells, each including a MEA. Each MEA includes a first electrode, a second electrode, and a membrane disposed between and in intimate contact with the first electrode and the second electrode. The vessel is disposed around the one or more electrochemical cells. A first storage area is defined by the vessel and the first electrode, wherein the first storage area is in fluid communication with the first electrode. A second storage area is defined by the second electrode, wherein the second storage area is in fluid communication with the second electrode. Because the first and second storage areas are in fluid communication with the first and second electrodes respectively, the need for external pumps and external storage areas is minimized or eliminated.

An exemplary embodiment of the electrochemical cell system, wherein the MEA is tubular, is shown in FIGS. 2 and 3. Electrochemical cell system 30 is enclosed in a vessel 32. Vessel 32 houses a tubular MEA comprising a hydrogen electrode 36 and an oxygen electrode 38 with a proton exchange membrane (electrolyte) 40 disposed therebetween. Of courts, the tubular MEA can have any cross-section, e.g. rectangular, square, octagonal, hexagonal, or other multi-sided geometry. A cylindrical shape is preferred for ease of manufacture. An oxygen storage area 42 is at the center of the electrochemical cell, defined by oxygen electrode 38 coaxially surrounding oxygen storage area 42. Further, a hydrogen storage area 44 is coaxially defined between hydrogen electrode 36 and vessel 32. Alternatively, the electrodes and adjacent storage areas may be reversed, such that the hydrogen storage area is interior to the MEA, and the oxygen storage area is defined between the MEA and the vessel.

Suitable materials for the MEA, comprising the membrane 40 and the electrodes 36, 38, can be conventional materials known for use in membrane assemblies. Membrane 40 can be selected from those typically employed for forming the membrane in electrochemical cells. The electrolytes are preferably solids or gels under the operating conditions of the electrochemical cell. Useful materials include proton conducting ionomers and ion exchange resins. Proton conducting ionomers comprise complexes of an alkali metal, alkali earth metal salt, or a protonic acid with one or more polar polymers such as a polyether, polyester, or polyimide, or complexes of an alkali metal, alkali earth metal salt, or a protonic acid with a network or crosslinked polymer containing the above polar polymer as a segment. Useful polyethers include polyoxyalkylenes, such as polyethylene glycol, polyethylene glycol monoether, polyethylene glycol diether, polypropylene glycol, polypropylene glycol monoether, and polypropylene glycol diether, and the like; copolymers of at least one of these polyethers, such as poly(oxyethylene-co-oxypropylene) glycol,poly(oxyethylene-co-oxypropylene) glycol monoether, and poly(oxyethylene-co-oxypropylene) glycol diether, and the like; condensation products of ethylenediamine with the above polyoxyalkylenes; esters, such as phosphoric acid esters, aliphatic carboxylic acid esters or aromatic carboxylic acid esters of the above polyoxyalkylenes. Copolymers of, e.g., polyethylene glycol with dialkylsiloxanes, polyethylene glycol with maleic anhydride, or polyethylene glycol monoethyl ether with methacrylic acid are known in the art to exhibit sufficient ionic conductivity to be useful. Useful complex-forming reagents can include alkali metal salts, alkali metal earth salts, and protonic acids and protonic acid salts. Counterions useful in the above salts can be halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, tetrafluoroethylene sulfonic acid, hexafluorobutane sulfonic acid, and the like.

Ion-exchange resins useful as proton conducting materials include hydrocarbon- and fluorocarbon-type resins. Hydrocarbon-type ion-exchange resins can include phenolic or sulfonic acid-type resins; condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of a tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is the NAFION® resins (DuPont Chemicals, Wilmington, Del.).

The electrodes 36, 38 can be conventional electrodes composed of materials such as platinum, palladium, rhodium, iridium, ruthenium, osmium, carbon, gold, tantalum, tin, indium, nickel, tungsten, manganese, and the like, as well as mixtures, oxides, alloys, and combinations comprising at least one of the foregoing materials. Additional possible catalysts materials that can be used alone or in combination with the above include graphite and organometallics, such as pthalocyanines and porphyrins, and combinations thereof, and the like. Some possible catalysts are disclosed in U.S. Pat. Nos. 3,992,271, 4,039,409, 4,209,591, 4,707,229, and 4,457,824, which are incorporated herein by reference. The catalyst can comprise discrete catalyst particles, hydrated ionomer solids, fluorocarbon, other binder materials, other materials conventionally utilized with electrochemical cell catalysts, and combinations comprising at least one of the foregoing catalysts. Useful ionomer solids can be any swollen (i.e. partially disassociated polymeric material) proton and water conducting material. Possible ionomer solids include those having a hydrocarbon backbone, and perfluoroionomers, such as perfluorosulfonate ionomers (which have a fluorocarbon backbone). lonomer solids and catalysts therewith are further described in U.S. Pat. No. 5,470,448 to Molter et al., which is incorporated herein by reference.

In order to allow transport of the electrons, the electrodes electrically connect to an electrical load and/or power source. The electrical connection can comprise any conventional electrical connector such as wires, a truss/bus rod, bus bars, combinations thereof, or another electrical connector.

The storage areas 42, 44, generally store the fluids (gases and/or liquids) for the system and may impart structural integrity. The storage areas 42, 44 preferably comprise a sufficient capacity to hold the desired amount of fluids for the given application. That is, the storage areas 42, 44 preferably hold the maximum amount of fluid that will be produced during the electrolytic and/or fuel cell operation. The vessel may optionally comprise external ports (not shown) for external fluid storage tanks (not shown). In another preferred embodiment, the storage area 42 contains water in a stoichiometric amount, such that during electrolysis, little or no unreacted water is dragged through the membrane 40, and after electrolysis, little or no water remains in either storage area 42, 44.

Although storage areas 42, 44 may be empty (except for the fluids stored therein), either or both of the storage areas 42, 44 typically function as flow fields. A porous structural electrode may accordingly be employed as either electrode 36, 38. Particularly, a porous structural electrode may be formed substantially throughout the center storage area 42 for additional structural integrity. Suitable porous structural electrodes are described in U.S. Provisional patent application Ser. No. 60/166,135, filed Nov. 18, 1999, Attorney Docket No. PES-0024 which is incorporated herein by reference.

Alternatively, storage areas 42, 44 may comprise porous materials, such as one or more tubular screens arranged concentrically. For example, as shown in FIGS. 2 and 3, the storage area 42 may comprise a perforated, metal sheet 46 having a plurality of openings 48, which surrounds a hollow storage area 50. Additional porous materials (such as a screen pack) may be optionally disposed in storage area 52 between metal sheet 46 and electrode 36. Solid materials, for example metal hydrides, may be associated with the porous material. Typically, the porous material is capable of providing structural integrity and supporting the membrane assembly, allowing passage of system fluids to and from the appropriate electrodes 36 or 38, and optionally conducting electrical current to and from the appropriate electrodes 36 or 38. The porous materials may be formed into a variety of shapes.

Preferred porous materials may comprise one or more layers of perforated or porous sheets, expanded metal, sintered metal particles, fabrics (woven or felt), polymers (e.g., electrically conductive, particulate-filled polymers), ceramics (e.g., electrically conductive, particulate-filled ceramics), or a woven mesh formed from metal or strands, as well as combinations comprising at least one of the foregoing layers. The sheets can have any cross-section, e.g. rectangular, square, octagonal, hexagonal, or other multi-sided geometry.

The porous materials are typically composed of electrically conductive material compatible with the electrochemical cell environment (for example, the desired pressures, preferably up to or exceeding about 10,000 psi, temperatures up to about 250° C., and exposure to hydrogen, oxygen, and water). Some possible materials include carbon, nickel and nickel alloys (e.g., Hastelloy®, which is commercially available from Haynes International, Kokomo, Indiana, Inconel®, which is commercially available from INCO Alloys International Inc., Huntington, West Virginia, among others), cobalt and cobalt alloys (e.g., MP35N®, which is commercially available from Maryland Specialty Wire, Inc., Rye, NY, Haynes 25, which is commercially available from Haynes International, Elgiloy®, which is commercially available from Elgiloye® Limited Partnership, Elgin, Illinois, among others), titanium, zirconium, niobium, tungsten, carbon, hafnium, iron and iron alloys (e.g., steels such as stainless steel and the like), among others, and oxides, mixtures, and alloys comprising at least one of the foregoing materials. The geometry of the openings in the porous materials can range from ovals, circles and hexagons to diamonds and other elongated shapes.

The particular porous material employed is dependent upon the particular operating conditions on that side of the membrane assembly. In a proton exchange membrane fuel cell, for example, the oxygen side screen pack can additionally store water. Furthermore, the electrical conductivity of the material may vary. For example, in the electrochemical cell system 30, where a single cell is employed and electrical conduction between a plurality of cell is not required, the porous material may have low electrical conductivity characteristics.

The vessel 32 is capable of containing the necessary components of the electrochemical cell, as well as providing storage areas for the products and reactants. The vessel can be any shape, e.g. rectangular, square, octagonal, hexagonal, or other multi-sided geometry. A cylindrical shape is preferred because of the greater pressures that may be contained by a cylinder.

The vessel 32 may be made out of any material that can withstand both the pressure of the internal components and the chemical effects of those components. Possible vessel materials include, but are not limited to, fluorocarbons, polycarbonates, polysulfones, polyetherimides, metals (including but not limited to niobium, zirconium, tantalum, titanium, steels, such as stainless steel, nickel, and cobalt, among others, as well as mixtures, oxides, and alloys comprising at least one of the foregoing metals), among others, as well as any conventionally used materials. System pressures may elevate up to about 500 pounds per square inch (psi), about 2000 psi, or about 10,000.

The storage areas 42, 44 and the MEA may be held in alignment by one or more endcaps (not shown). Optionally, the endcaps provide electrical contact for the electrical system 30. These endcaps can be any material capable of withstanding the operating environment (including pressures, temperatures, and chemicals), and having sufficient structural integrity to maintain a seal between the environment and the interior of the vessel 32. The endcaps can also have ports for connection of the storage areas 42, 44 to external storage/supply sources. The vessel 32, and consequently the entire electrochemical system, may be of any size, and may contain a single cell, or multiple cells, and will typically be configured to suit the power and time demands for a specific application. Preferably, the vessel, the first storage area, the membrane electrode assembly, and the second storage area are coaxially aligned. Even more preferably, the vessel, the first storage area, the membrane electrode assembly, and the second storage area are concentric, that is, have circular cross-sections that are coaxially aligned.

During the energy storage cycle of the system, oxygen (and any excess water) is stored in storage area 42, while the hydrogen is stored in storage area 44. In the energy production cycle of the system, water (and any excess oxygen) is stored is stored in storage area 42, while excess hydrogen is stored in storage area 44.

The electrochemical cell system 30 can be initially charged by an external power source. The system 30 is operating as an electrolyzer in this stage, and water (or other liquid reactant such as hydrogen bromide) is separated for example, into hydrogen and oxygen. The hydrogen and oxygen are stored in their respective areas 44, 42 within the vessel 32, and, after reaching an operating pressure, charge secures automatically. That is, the external power source can be disconnected and an electrical load can be attached to the charged system. The system can then operate as a fuel cell, recombining the hydrogen and oxygen into water, while producing an electrical current. When current production ceases or reaches a predetermined level, the system is regenerated by again charging with an external power source such as a photovoltaic cell or other power source.

The hydrogen produced can be stored as high pressure gas, or alternatively, in a solid form, such as a metal hydride, a carbon based storage (e.g. particulates, nanofibers, nanotubes, or the like), or others, and combinations comprising at least one of the foregoing storage mediums. In one embodiment, for example, the hydrogen storage area 44 comprises one or more metal hydrides capable of releasing gaseous hydrogen, typically upon the application of heat. The released hydrogen forms hydrogen ions on the hydrogen electrode and travels through the membrane and to combine with oxygen as before. Alternatively, when hydrogen is produced, it moves to the storage area, which is typically under a predetermined pressure based upon the particular metal hydride employed. In the hydrogen storage area 44 the hydrogen is bound by the metal hydride. The use of solid hydrogen storage allows for a reduction in the hydrogen storage area 44, which thereby allows for an overall reduction in the size of the electrochemical cell system 30.

An air feed system may also be employed with the current invention. In an air feed system, air can be introduced to the oxygen electrode via the use of pumps or the like. Further, a convective air feed system can be employed, where the air convects across the electrode.

The electrochemical cell system herein enables remote use of electrochemical cells due to its simplified design, which eliminates or minimizes the need for pumps, external storage and supply tanks, and other peripheral equipment. Although this system can readily be connected to such external equipment, the external equipment is not required. Furthermore, this system is regenerable, which enables electricity generation during the night with recharging during the day via one or more photovoltaic cells, for example

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An electrochemical cell system, comprising:
a membrane electrode assembly comprising a first electrode, a second electrode, and a membrane disposed between and in intimate contact with the first electrode and the second electrode; and
a vessel disposed around the membrane electrode assembly, the vessel defining a first storage area in fluid communication with the first electrode and the membrane electrode assembly defining a second storage area in fluid communication the second electrode.

2. The electrochemical cell system of claim 1, wherein the membrane electrode assembly is tubular.

3. The electrochemnical cell system of claim 2, wherein the vessel, the first storage area, the membrane electrode assembly, and the second storage area are coaxially aligned.

4. The electrochemical cell system of claim 2, wherein the vessel, the first storage area, the membrane electrode assembly, and the second storage area are concentric.

5. The electrochemical cell system of claim 1, wherein the first storage area, the second storage area, or both comprises porous material.

6. The electrochemical cell system of claim 1, wherein the first storage area comprises metal hydride.

7. The electrochemical cell system of claim 1, wherein the first storage area comprises carbon nanofibers, carbon nanotubes, metal hydrides, or mixtures of at least one of the foregoing materials.

8. The electrochemical cell system of claim 2, further comprising a tubular screen pack adjacent to the second electrode, a tubular perforated sheet adjacent to the screen pack, and a hollow area within the perforated sheet.

9. An electrochemical cell system, comprising:
a tubular membrane electrode assembly comprising a first electrode, a second electrode, and a membrane disposed between and in intimate contact with the first electrode and the second electrode; and
a vessel disposed around the membrane electrode assembly, the vessel defining a first storage area in fluid communication with the first electrode and the membrane electrode assembly defining a second storage area in fluid communication the second electrode.

10. An electrochemical cell system, comprising:
a tubular membrane electrode assembly comprising a first electrode, a second electrode, and a membrane disposed between and in intimate contact with the first electrode and the second electrode; and
a vessel disposed around the membrane electrode assembly, the vessel defining a first storage area in fluid communication with the first electrode and the membrane electrode assembly defining a second storage area in fluid communication the second electrode, wherein the vessel, the first storage area, the membrane electrode assembly, and the second storage area are coaxially aligned.

11. An electrochemical cell system, comprising:
a tubular membrane electrode assembly comprising a first electrode, a second electrode, and a membrane disposed between and in intimate contact with the first electrode and the second electrode; and
a vessel disposed around the membrane electrode assembly, the vessel defining a, first storage area in fluid communication with the first electrode and the membrane electrode assembly defining a second storage area in fluid communication the second electrode, wherein the vessel, the first storage area, the membrane electrode assembly, and the second storage area are concentric.

12. A method of operating an electrochemical cell system comprising:
introducing, to the first electrode of a membrane electrode assembly comprising a first electrode, a second electrode, and a membrane disposed between and in intimate contact with the first electrode and the second electrode, a first fluid from a first storage area in fluid communication with the first electrode, wherein the first storage area is further defined by a vessel disposed around the membrane electrode assembly;
reacting the first fluid on the first electrode to form ions that migrate across a membrane to the second electrode;
forming a second fluid at the second electrode; and
passing said second fluid into a second storage formed by the second electrode.

13. The method of claim 12, wherein the reaction is electrolysis, and water for the electrolysis is water present in the second storage area.

14. The method as in claim 13, wherein water is present in a stoichiometric quantity.

15. The method as in claim 12, wherein the voltage applied for electrolysis is released after electrolysis.
